(19) United States
(12) Patent Application Publication
(10) Pub. No.: US 2012/0200486 A1
(43) Pub. Date: Aug. 9, 2012

(54) Infrared gesture recognition device and method

(75) Inventors: Walter B. Meinel, Tucson, AZ (US); Kalin V. Lazarov, Colorado Springs, CO (US); Timothy V. Kalthoff, Tucson, AZ (US)

(73) Assignee: Texas Instruments Incorporated

(21) Appl. No.: 12/931,783

(22) Filed: Feb. 9, 2011

(51) Int. Cl. G09G 5/00

(52) U.S. Cl. 345/156

(57) ABSTRACT

A system for generating tracking coordinate information in response to movement of an information-indicating element includes an array (55) of IR sensors (60-x,y) disposed along a surface (55A) of the array. Each IR sensor includes first (7) and second (8) thermopile junctions connected in series to form a thermopile (7,8) within a dielectric stack (3) of a radiation sensor chip (1). The first thermopile junction is more thermally insulated from a substrate (2) of the radiation sensor chip than the second thermopile junction. A sensor output signal between the first and second thermopile junctions is coupled to a bus (63). A processing device (64) is coupled to the bus for operating on information representing temperature differences between the first and second thermopile junctions of the various IR sensors, respectively, caused by the presence of the information-indicating element to produce the tracking coordinate information as the information-indicating element moves along the surface.

### BACKGROUND OF THE INVENTION

The present invention relates generally to gesture recognition devices and methods, and more particularly to such devices and methods which include infrared sensors.

Various systems for translating hand position/movement into corresponding digital data to be input to a computing system are well-known. For example, digital pens, computer mouses, and various kinds of touch screens and touch pads are known. Various other systems for translating hand position/movement into digital data which is input to a computer system to accomplish gesture recognition and/or writing and/or drawing based on touchless hand motion also are well-known. For example, see the article “Gesture Recognition with a Wii Controller” by Thomas Schlomer et al., TEI '08 Proceedings Of the Second International Conference on Tangible and Embedded, Interaction TEI conference on Tangible and Embedded Interaction, 2008, ISBN: 978-1-60558-004-3; this article is incorporated herein by reference. The Schlomer article discloses the design and evaluation of a sensor-based gesture recognition system which utilizes the accelerometer contained in the well-known Wii-controller (Wiimote™) as an input device. The system utilizes a Hidden Markov Model for training and recognizing user-chosen gestures, and includes filtering devices ahead of a data pipeline including a gesture recognition quantizer, a gesture recognition model, and a gesture recognition classifier. The quantizer applies a common k-mean algorithm to the incoming vector data. The model is implemented by means of the Hidden Markov Model, and the classifier is chosen to be a Bayes classifier. The filters establish a minimum representation of a gesture before being forwarded to the Hidden Markov Model by eliminating all vectors which do not significantly contribute to a gesture and also eliminate vectors which are roughly equivalent to their predecessor vectors.

Prior Art FIG. 1 illustrates another known gesture recognition system for human-robot interaction, and is similar to FIG. 1 in the article “Visual Recognition of Pointing Gestures for Human-Robot Interaction” by K. Nickel, R. Steifelhagen, Image in Vision Computing (2006), pages 1-10; this article is also incorporated herein by reference. In Prior Art FIG. 1, a camera system 5 generates image data which is transmitted on RGB cable 10. The image data is input to a head orientation module 9 and is also input to a skin color classification module 22 and a face detection module 29. The skin color classification is needed to help distinguish arms from hands, i.e., from palms and fingers.

The output of face detection module 29 is applied via bus 30 as an input to skin color classification module 22. Stereo camera system 5 also outputs image disparity information on bus 6 which is input to head orientation module 9 and multi-hypothesis tracking module 26. (The term “disparity” refers to the difference between images generated by the two stereo cameras in Prior Art FIGS. 1 and 2, each of which shows a 3-dimensional gesture or hand movement recognition system.) Skin color classification module 22 in Prior Art FIG. 1 produces “skin map” information 25 as another input to multi-hypothesis tracking module 26, the output of which constitutes head/hand position information that is input via bus 31 to head orientation module 9 and gesture recognition module 21. Head orientation module 9 generates pan/tilt angle information 17 that also is input to gesture recognition module 21. Gesture recognition module 21 generates gesture event data 32 which indicates specific gestures being observed by camera system 5.

Three-dimensional head and hand tracking information generated by multi-hypothesis tracking module 26 is utilized along with head orientation information generated by module 9 to model the dynamic motion, rather than just the static position, of pointing gestures and thereby significantly improves the gesture recognition accuracy.

Conventional Hidden Markov Models (HMMs) are utilized in gesture recognition module 21 to perform the gesture recognition based on the outputs of multi-hypothesis tracking module 26 and head orientation module 9. Based on the hand motion and the head motion and orientation, the HMM-based classifier in gesture recognition module 21 is trained to detect pointing gestures to provide significantly improved real-time gesture recognition performance which is suitable for applications in the field of human-robot interaction.

The head and hands of the subject making gestures are identified by means of human skin color clusters in a small region of the chromatic color space. Since a mobile robot has to cope with frequent changes in light conditions, the color model needs to be continuously updated to accommodate changes in ambient light conditions. In order to accomplish this, face detection module 29 searches for a face image in the camera image data by running a known fast face detection algorithm asynchronously with the main video loop, and a new color model is created based on the pixels within the face region whenever a face image is detected. That information is input via path 30 to skin color classification module 22, which then generates the skin map information 25 as an input to multi-hypothesis tracking module 26.

Multi-hypothesis tracking module 26 operates to find the best hypotheses for the positions of the subject's head and hands at each time frame “t”, based on the current camera observation and the hypotheses of past time frames. The best hypotheses are formulated by means of a probabilistic framework that includes an observation score, a posture score, and a transition score. With each new frame, all combinations of the three-dimensional skin cluster centroids are evaluated to find the hypothesis that exhibits the best results with respect to the product of the three observation, posture, and transition scores. Accurate tracking of the relatively small, fast moving hands is a difficult problem compared to the tracking of the head. Accordingly, multi-hypotheses tracking module 26 is designed to be able to correct its present decision instead of being tied to a previous wrong decision by performing multi-hypotheses tracking to allow “rethinking” by keeping an n-best list of hypotheses at each time frame wherein each hypothesis is connected within a tree structure to its predecessor, so multi-hypothesis tracker 26 is free to choose the path that maximizes the overall probability of a correct new decision based on the observation, posture and transition scores.

The resulting head/hand position information generated on bus 31 by multi-hypothesis tracking module 26 is provided as an input to both gesture recognition module 21 and head orientation module 9. Head orientation module 9 uses that information along with the disparity information 6 and RGB image information 10 to generate pan/tilt angle information input via bus 17 to gesture recognition module 21. Head orientation module 9 utilizes two neural networks, one for determining the pan angle of the subject's head and one for determining the tilt angle thereof based on the head's intensity data and disparity image data.

Gesture recognition module 21 models the typical motion pattern of pointing gestures rather than just the static posture of a person during the peak of the gesture) by decomposing the gesture into three distinct phases and modeling each phase with a dedicated Hidden Markov Model, to thereby provide improved accurate pointing gesture recognition. (Note that use of Hidden Markov Model for gesture recognition is a known technique.)

The above-mentioned gesture recognition quantizer in Prior Art FIG. 1 uses the location of the peak values from each time frame to calculate the vector of the gesture. The most common algorithm, often called the k-means algorithm, uses an iterative refinement technique. The k-means clustering algorithm is used to interpret the vector motion in terms of a recognized command or phrase. Given an initial set of k means m1(1), . . . ,mk(1), which may be specified randomly or by a heuristic, the k-means clustering algorithm proceeds by alternating between successive “assignment” and “updating” steps. Each assignment step includes assigning each observation to the cluster having the mean closest to the observation. That is, the observations are partitioned according to a Voronoi diagram generated by the means. Each updating step includes calculating the new means to be the centroid of the observations in the cluster. The algorithm is deemed to have converged when the assignments no longer change. A detailed description of k-means clustering appears in the article that appears at the website http://en.wikipedia.org/wiki/K-means_clustering, and a copy of that article is included with the Information Disclosure Statement submitted with this patent application and is incorporated herein by reference.

The above mentioned gesture recognition model takes multiple sequential gesture vectors and determines their meanings using the Hidden Markov Model (HMM). Hidden Markov models are especially known for their application in temporal pattern recognition, and they work well for gesture recognition. A detailed description of the Hidden Markov Model is included in the article that appears at the website http://en.wikipedia.org/wiki/Hidden_Markov_Model, and a copy of that article is included with the Information Disclosure Statement submitted with this patent application, and is incorporated herein by reference.

The above mentioned the gesture recognition classifier may use a naïve Bayes classifier to interpret the gesture series and determine the desired action represented by the gesture. Naive Bayes classifiers have worked quite well in many complex real-world situations and can be trained very efficiently in a supervised setting. A detailed description of the naïve Bayes classifier appears in the article that appears at the Web site http://en.wikipedia.org/wiki/Naive_Bayes_classifier, and a copy of that article is included with the Information Disclosure Statement submitted with this patent application, and is incorporated herein by reference.

Prior Art FIG. 2 shows a block diagram of a system for utilizing two video cameras to track movement of a human hand and accordingly provide images that represent writing or drawing traced by the hand movement. Prior Art FIG. 2 is essentially the same as FIG. 2 in the article “Employing the Hand As an Interface Device” by Afshin Sepehri et al., Journal of Multimedia, Vol. 1,No. 7, November/December 2006, pages 18-29, which is incorporated herein by reference. In FIG. 2, the outputs of a right video camera 5R and a left video camera 5L are input to image rectification modules 33R and 33L, respectively. (The modules shown in the diagrams of FIGS. 1 and 2 can be considered to be portions of a single computer configured to execute programs that perform the indicated functions.) The outputs of image rectification modules 33R and 33L are input to background subtraction modules 35R and 35L, respectively. The outputs of background subtraction modules 35R and 35L are input to color detection modules 36R and 36L, respectively. The outputs of color detection modules 36R and 36L are input to region of interest selection modules 37R and 37L, respectively. The output of region of interest selection module 37R is provided as an input to a motion field estimation module 38 and also to a disparity map estimation module 39. The output of region of interest selection module 37R is also input to disparity map estimation module 39. The Z⁻¹ notation adjacent to output 40 of block 37R indicates use of the well-known Z-transform. In mathematics and signal processing, the Z-transform converts a discrete time-domain signal, which is a sequence of real or complex numbers, into a complex frequency-domain representation. See the article “Z-transform”, available at http://en.wikipedia.org/wiki/Z-transform. A copy of that article is included with the Information Disclosure Statement submitted with this patent application, and is incorporated herein by reference.

The output 41 of motion field estimation module 38 is input to motion modeling module 43, the output of which is input to 2D (two-dimensional) reference point tracking module 46. The output 42 of disparity map estimation module 39 is input to disparity modeling module 44, the output of which is input to 3D reference point tracking module 48. The output 47 of 2D reference point tracking module 46 is provided as another input to 3D reference point tracking module 48 and also is fed back as a Z⁻¹ input to 2D reference point tracking module 46. The output of 3D reference point tracking module 48 is input to an incremental planar modeling module 49, the output of which is input to on-plane, off-plane analysis module 50. The output 51 of on-plane, off-plane analysis module 50 is provided as an input to 3D to 2D projection module 52 and also is fed back as a Z⁻¹ input to on-plane, off-plane analysis module 50. The output of 3D to 2D projection module 52 is input to an output normalization module 53, the output 32 of which includes normalized coordinates of the movement of the hand centroids.

In the system shown in FIG. 2 images of a hand(s) are grabbed by stereo cameras 5R and 5L. Image rectification modules 33R and 33L rectify the grabbed images in order to achieve faster disparity map estimation by disparity map estimation module 39. Background subtraction modules 35R and 35L and skin color detection modules 36R and 36L operate to “segment” the hand image. (A fusion of color and background subtraction is utilized to extract the hand image, with the color analysis applied to the results of the background subtraction. Background subtraction is simply implemented using a unimodal background model, followed by color skin detection and finally followed by a flood fill filtering step.)

Region of interest selection modules 37R and 37L operate to remove the fingers and the arm of the camera images from the hand image so only the central region of the hand images (i.e. palm, back of the hand images) remains. The disparity map estimation module 39 estimates a disparity map from the two camera images taken at each time instant, using a parametric planar model to cope with the nearly textureless surface of the selected portion of the hand image. Motion field estimation module 38 operates to estimate a monocular motion field from two consecutive time frames in a process that is similar to the estimating of the disparity map in module 39. Motion modeling module 43 operates to adjust parameters of the motion model to comply with the disparity model. The motion field then is used by 2D reference point tracking module 46 and 3D reference point tracking module 48 to track selected points throughout the sequence. At each time instant, the X, Y and Z coordinates of the position and the orientation angles yaw, pitch, and roll of the hand image are calculated for a coordinate frame that is “attached” to the palm of the selected portion of the hand image. The 3D plane parameters are calculated by incremental planar modeling module 49 and on-plane, off-plane analysis module 50 from the disparity plane information established by disparity modeling module 44. For tracking the hand image over time, a set of 2D image points are extracted from the images of one of the two cameras 5R and 5L and its motion model. Then, using disparity models established by disparity modeling module 44 at different times, the motion coordinates of that hand image are mapped to the 3D domain to provide the trajectory of the hand image in space.

On-plane and off-plane analysis module 50 operates to determine when the centroid of the selected portion of the hand image undergoes a significant deviation from a computed plane fitted to the palm of hand to indicate the hand being lifted from the virtual plane in order to indicate a particular drawing/writing movement. 3D to 2D projection module 52 operates to convert the set of 3D points to the best approximated set in two dimensions. Output normalization module 53 then operates to generate hand coordinate tracking data that represents on-plane writing or drawing performed by the user. The hand movement detection and tracking system of FIG. 2 also has to deal with the complexity of dealing with all of the pixels in each camera, and it generates hand movement data which then is input to a utilization system for particular desired purpose, which may but does not necessarily include gesture recognition. The above described “modules” in FIGS. 1 and 2 are software modules that can be executed within one or more processors or the like.

A significant shortcoming of the above described prior art is that the input sensor response times are much slower than is desirable for many hand movement tracking applications and/or for many gesture recognition applications, due to the amount of computer resources required. Also, the ambient lighting variance strongly influences the interpretation of the details and adds significant difficulty in image capture.

There is an unmet need for an improved, faster, less expensive, simpler, and more accurate way of translating various element movements such as hand movements and/or hand gestures into coordinate or vector information representing element or hand position/movement.

There also is an unmet need for an improved, faster, less expensive, and more accurate way of translating various hand movements and/or hand gestures into corresponding input signals for a computer system so there is no need for any part of the hand (or an instrument held by the hand) to actually touch any part of the computer system.

There also is an unmet need for a faster way of generating a vector in response to element movement, and a movement, or the like.

There also is an unmet need for a faster, lower cost, more accurate device and method for translating element or hand movement into digital input information for an operating system.

There also is an unmet need for a faster, lower cost, more accurate device and method for translating element or hand movement into digital input information which simplifies gesture recognition algorithms by avoiding use of external lighting and associated color filtering.

There also is an unmet need for a faster, lower cost, more accurate device and method for translating element or hand movement into digital input information which is very insensitive to ambient lighting conditions.

### SUMMARY OF THE INVENTION

It is an object of the invention to provide an improved, faster, less expensive, simpler, and more accurate way of translating various element movements such as hand movements and/or hand gestures into coordinate or vector information representing element or hand position and/or movement.

It is another object of the invention to provide an improved, faster, less expensive, simpler, and more accurate way of translating various element movements such as hand movements and/or hand gestures into corresponding input signals for a computer system so that there is no need for any part of the hand (or an instrument held by the hand) to actually touch any part of the computer system.

It is another object of the invention to provide a faster way of generating a vector in response to an element or hand movement or the like.

It is another object of the invention to provide a faster, lower cost, more accurate device and method for translating element movement or hand movement or the like into digital input information for an operating system.

It is another object of the invention to provide a faster, lower cost, more accurate device and method for translating element or hand movement into digital input information which simplifies gesture recognition algorithms by avoiding use of external lighting and associated color filtering.

It is another object of the invention to provide a faster, lower cost, more accurate device and method for translating element or hand movement into digital input information which is very insensitive to ambient lighting conditions.

Briefly described, and in accordance with one embodiment, the present invention provides a system for generating tracking coordinate information in response to movement of an information-indicating element, including an array (55) of IR sensors (60-x,y) disposed along a surface (55A) of the array. Each IR sensor includes first (7) and second (8) thermopile junctions connected in series to form a thermopile (7,8) within a dielectric stack (3) of a radiation sensor chip (1). The first thermopile junction is more thermally insulated from a substrate (2) of the radiation sensor chip than the second thermopile junction. A sensor output signal generated between the first and second thermopile junctions is coupled to a bus (63). A processor (64) is coupled to the bus for operating on information that represents temperature differences between the first and second thermopile junctions of the various IR sensors, respectively, caused by the presence of the information-indicating element to produce the tracking coordinate information as the information-indicating element moves along the surface.

In one embodiment, the invention provides a system for generating tracking coordinate information in response to movement of an information-indicating element, including an array (55) of IR (infrared) sensors (60-x,y) disposed along a surface (55A) of the array (55). Each IR sensor (60-x,y) includes first (7) and second (8) thermopile junctions connected in series to form a thermopile (7,8) within a dielectric stack (3) of a radiation sensor chip (1). The first thermopile junction (7) is more thermally insulated from a substrate (2) of the radiation sensor chip (1) than the second thermopile junction (8). A sensor output signal between the first (7) and second (8) thermopile junctions is coupled to a bus (63), and a processing circuit (64) is coupled to the bus (63) to receive information representing temperature differences between the first (7) and second (8) thermopile junctions of the various IR sensors (60-x,y), respectively, caused by the presence of the information-indicating element. The processing circuit (64) operates on the information representing the temperature differences to produce the tracking coordinate information as the information-indicating element moves along the surface (55A).

In one embodiment, the surface (55A) lies along surfaces of the substrates (2) of the radiation sensor chips (1). Each first thermopile junction (7) is insulated from the substrate (2) by means of a corresponding cavity (4) between the substrate (2) and the dielectric stack (3). A plurality of bonding pads (28A) coupled to the thermopile (7,8) are disposed on the radiation sensor chip (1), and a plurality of bump conductors (28) are attached to the bonding pads (28A), respectively, for physically and electrically coupling the radiation sensor chip (1) to conductors (23A) on a circuit board (23).

In one embodiment, the dielectric stack (3) is a CMOS semiconductor process dielectric stack including a plurality of SiO₂ sublayers (3-1,2 . . . 6) and various polysilicon traces, titanium nitride traces, tungsten contacts, and aluminum metalization traces between the various sublayers patterned to provide the first (7) and second (8) thermopile junctions connected in series to form the thermopile (7,8). Each IR sensor (60-x,y) includes CMOS circuitry (45) coupled between first (+) and second (−) terminals of the thermopile (7,8) to receive and operate on a thermoelectric voltage (Vout) generated by the thermopile (7,8) in response to infrared (IR) radiation received by the radiation sensor chip (1). The CMOS circuitry (45) also is coupled to the bonding pads (28A). The CMOS circuitry (45) converts the thermoelectric voltage (Vout) to digital information in an I²C format and sends the digital information to the processing circuit (64) via the bus (63). The processing circuit (64) operates on the digital information to generate a sequence of vectors (57) that indicate locations and directions of the information-indicating element as it moves along the surface (55A).

In one embodiment, the information-indicating element includes at least part of a human hand, and the processing circuit (64) operates on the vectors to interpret gestures represented by the movement of the hand along the surface (55A).

In one embodiment, the IR sensors (60-x,y) are represented by measured pixels (60) which are spaced apart along the surface (55A). In one embodiment, the IR sensors (60-x,y) are disposed along a periphery of a display (72) to produce temperature differences between the first (7) and second (8) thermopile junctions of the various IR sensors (60-x,y) caused by the presence of the information-indicating element as it moves along the surface of the display (72). In one embodiment, IR sensors (60-x,y) are represented by measured pixels (60) which are spaced apart along the surface (55A), and the processing circuit (64) interpolates values of various interpolated pixels (60A) located between various measured pixels (60).

In one embodiment, the substrate (2) is composed of silicon to pass infrared radiation to the thermopile (7,8) and block visible radiation, and further includes a passivation layer (12) disposed on the dielectric stack (3) and a plurality of generally circular etchant openings (24) located between the various traces and extending through the passivation layer (12) and the dielectric layer (3) to the cavity (4) for introducing silicon etchant to produce the cavity (4) by etching the silicon substrate (2).

In one embodiment, the radiation sensor chip (1) is part of a WCSP (wafer chip scale package).

In one embodiment, the invention provides a method for generating tracking coordinate information in response to movement of an information-indicating element, including providing an array (55) of IR (infrared) sensors (60-x,y) disposed along a surface (55A) of the array (55), each IR sensor (60-x,y) including first (7) and second (8) thermopile junctions connected in series to form a thermopile (7,8) within a dielectric stack (3) of a radiation sensor chip (1), the first thermopile junction (7) being more thermally insulated from a substrate (2) of the radiation sensor chip (1) than the second thermopile junction (8), a sensor output signal between the first (7) and second (8) thermopile junctions being coupled to a bus (63); coupling a processing circuit (64) to the bus (63); operating the processing circuit (64) to receive information representing temperature differences between the first (7) and second (8) thermopile junctions of the various IR sensors (60-x,y), respectively, caused by the presence of the information-indicating element; and causing the processing circuit (64) to operate on the information representing the temperature differences to produce the tracking coordinate information as the information-indicating element moves along the surface (55A).

In one embodiment, substrate (2) is composed of silicon to pass infrared radiation to the thermopile (7,8) and block visible radiation, wherein the method includes providing the surface (55A) along surfaces of the substrates (2) of the IR sensors (60-x,y) and providing a cavity (3) between the substrate (2) and the first thermopile junction (7) to thermally insulate the first thermopile junction (7) from the substrate (2).

In one embodiment, the method includes providing the radiation sensor chip (1) as part of a WCSP (wafer chip scale package).

In one embodiment, the bus (63) is an I²C bus, and the method includes providing I²C interface circuitry coupled between the I²C bus and first (+) and second (−) terminals of the thermopile (7,8). In one embodiment, the method includes providing CMOS circuitry (45) which includes the I²C interface circuitry in each IR sensor (60-x,y) coupled between the first (+) and second (−) terminals of the thermopile (7,8) to receive and operate on a thermoelectric voltage (Vout) generated by the thermopile (7,8) in response to infrared (IR) radiation received by the radiation sensor chip (1).

In one embodiment, the invention provides a system for generating tracking coordinate information in response to movement of an information-indicating element, including an array (55) of IR (infrared) sensors (60-x,y) disposed along a surface (55A) of the array (55), each IR sensor (60-x,y) including first (7) and second (8) thermopile junctions connected in series to form a thermopile (7,8) within a dielectric stack (3) of a radiation sensor chip (1), the first thermopile junction (7) being more thermally insulated from a substrate (2) of the radiation sensor chip (1) than the second thermopile junction (8), a sensor output signal between the first (7) and second (8) thermopile junctions being coupled to a bus (63); and processing means (64) coupled to the bus (63) for operating on information representing temperature differences between the first (7) and second (8) thermopile junctions of the various IR sensors (60-x,y), respectively, caused by the presence of the information-indicating element to produce the tracking coordinate information as the information-indicating element moves along the surface (55A).

### BRIEF DESCRIPTION OF THE DRAWINGS

FIG. 1 is a block diagram of a known gesture recognition system receiving gesture information from a video camera system.

FIG. 2 is a flow diagram of the operation of another known gesture recognition system that receives gesture information from a video camera system.

FIG. 3 is a plan view diagram of an array of infrared sensors used for generating movement vector information to be input to a gesture recognition system.

FIG. 4 is a section view of an infrared sensor from the array shown in FIG. 3.

FIG. 5 is a side elevation view diagram of a WCSP package including one or more infrared sensors as shown in FIG. 4.

FIG. 6 is a plan view diagram illustrating a gesture recognition system including the array of infrared sensors shown in FIG. 3, an interface system, and a microprocessor which performs a gesture recognition process on gesture vector information received from the infrared sensors.

FIG. 7 is a plan view diagram illustrating measured pixels corresponding to individual infrared sensors and also illustrating interpolated pixels located between measured pixels and used by a gesture recognition process to improve resolution.

FIG. 8 is a plan view diagram as in FIG. 7 further illustrating a gesture vector computed according to pixel information from the pixel array shown in FIG. 7.

FIG. 9 is a plan view diagram as in FIG. 7 illustrating an array of IR sensors disposed around a display screen, touchscreen, or the like.

### DETAILED DESCRIPTION OF THE PREFERRED EMBODIMENTS

The embodiments of the invention described below may be used to improve the previously described prior art by avoiding the cost and complexity of using video cameras to sense hand movement and also by avoiding the slowness of data manipulation required by the use of the cameras. The described embodiments of the invention also avoid any need for external lighting and associated color filtering to thereby significantly simplify hand movement and/or gesture recognition algorithms that may be needed in some applications.

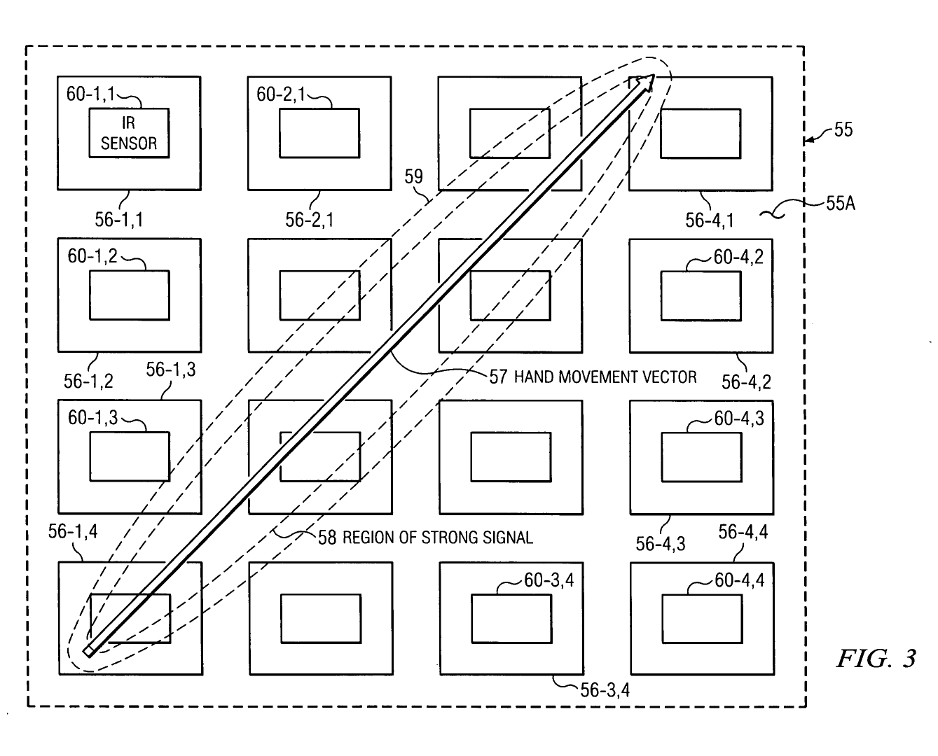

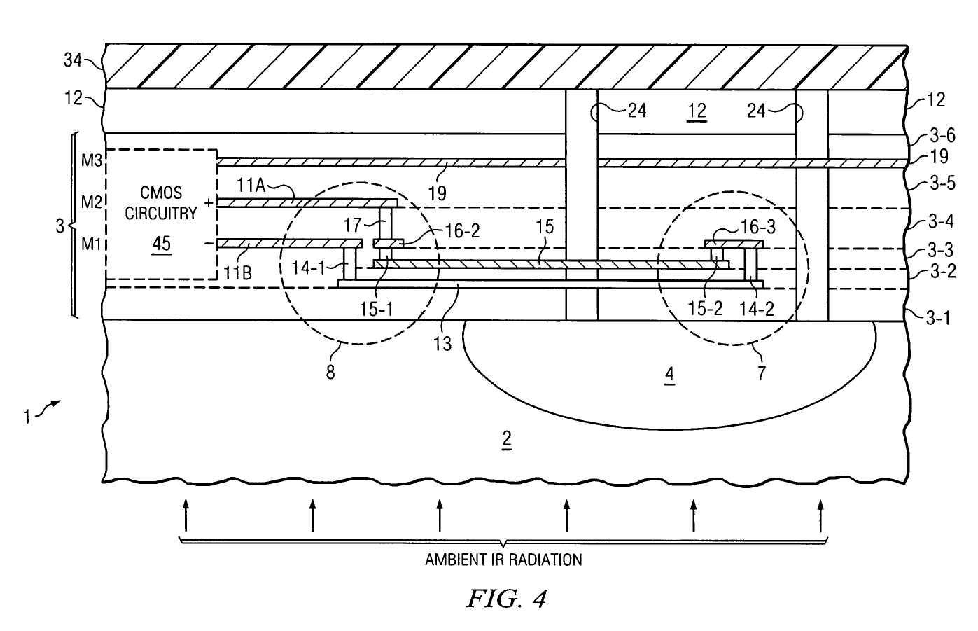

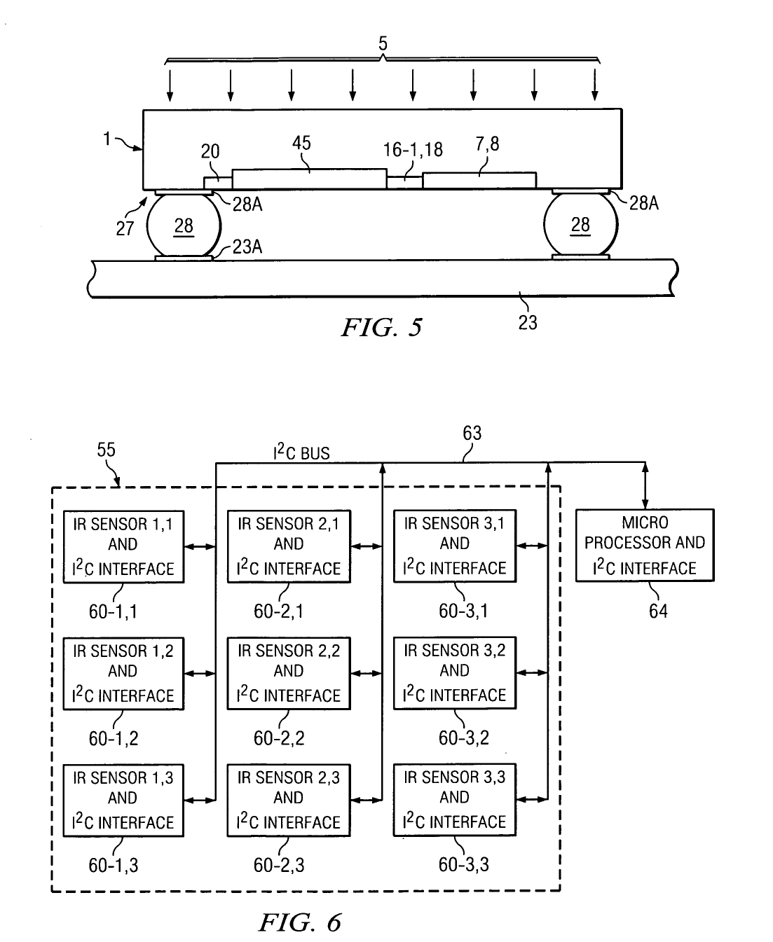

Referring to the example of FIG. 3, a 4×4 infrared (IR) sensor array 55 includes 16 IR sensors 60-x,y, where the column index “x” has values 1 through 4 and the row index “y” also has values 1 through 4. (Note that “x” and “y” may have the values much larger than 4 in many typical applications.) IR sensors 60-x,y are located at or along the upper surface 55A of array 55. Each of IR sensors 60-x,y may have the structure shown in subsequently described FIG. 4. In the example of FIG. 3, each IR sensor 60-x,y is packaged in a corresponding WCSP package 56-x,y. Each WCSP (Wafer Chip Scale Package) package may have the structure shown in subsequently described FIG. 5.

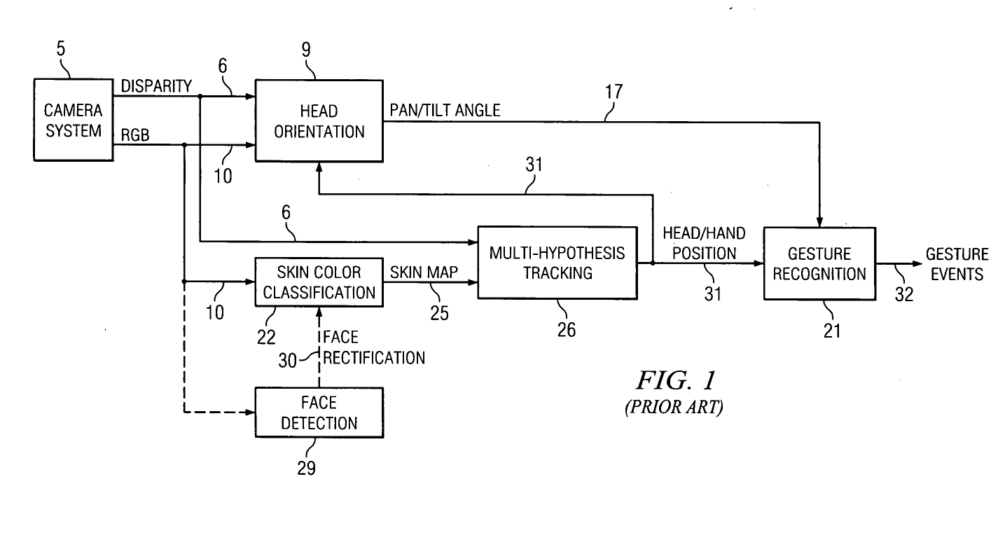

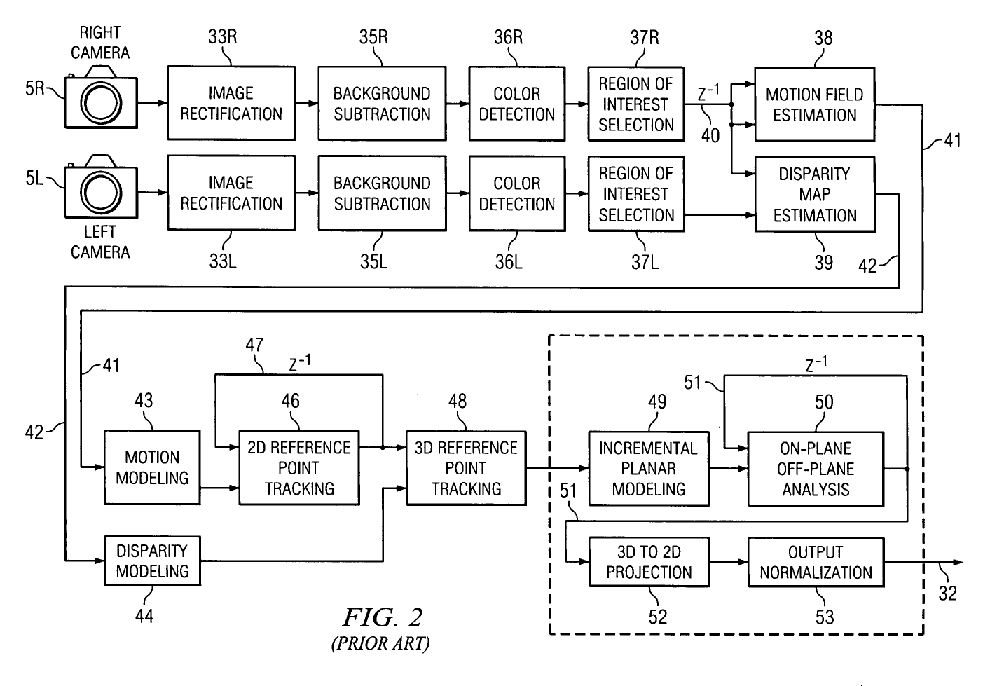

In the example of FIG. 3, hand movement vector 57 represents a time sequence of data from multiple frames or scans of the infrared array representing the combined output signals generated by movement of a hand (not shown but also represented by hand movement vector 57) across the surface of IR sensor array 25 caused by temperature changes introduced into the thermopile junctions of IR sensors 60-x,y in response to the presence of the hand. Dashed line 58 surrounds a region of IR sensor array 55 in which the output signals produced by IR sensors 60-x,y in response to the presence of the hand are relatively strong, and dashed line 59 surrounds an annular region of IR sensor array 55 that is also bounded by dashed line 58 wherein the output signals produced by IR sensors 60-x,y are relatively weak. Each of the various IR sensors in the present invention each performs the same basic function as a single camera in the prior art systems of Prior Art FIGS. 1 and 2. However, when video cameras are used to capture images of the hand movement, the subsequently required image processing may be much more complex than desirable because a processor or computer must receive all of the data from all of the pixels of the camera-generated images and simplify that data before it can begin determining the locations and directions of the hand movement vectors.

The basic system described in the example of FIG. 3 is two-dimensional in the sense that all of the IR sensors 60-x,y lie in the same plane, and this makes it easier for the computer to deal with the information produced by the IR sensors 60-x,y. (However, note that the IR sensor array surface may be convex or concave, as well as planar.) The described IR sensor array 55 is capable of providing of more accurate vectors because it does not need to deal with differentiating fingers from hands, and so forth, because of the fact that it is self-illuminated, i.e., no external illumination is required. (Self illumination by an object means that light is being emitted from the object rather than being reflected from it and therefore the self illumination will be less sensitive to external light conditions.) Another reason that the described IR sensor array 55 is capable of generating the vectors more accurately is because the resolution of the IR sensors or pixels may be lower than is the case when the other sensors are used. Since the main objective of gesture recognition is to form a simple command or statement, any extraneous data can make interpretation of the gesture more difficult. Therefore, the lower resolution automatically filters out minor details.

FIGS. 4 and 5 and associated text below are taken from the assignee's pending patent application “Infrared Sensor Structure and Method”, application Ser. No. 12/380,316 filed Feb. 26, 2009 by Meinel et al., published Aug. 26, 2010 as Publication Number US 2010/0213373, and incorporated herein by reference.

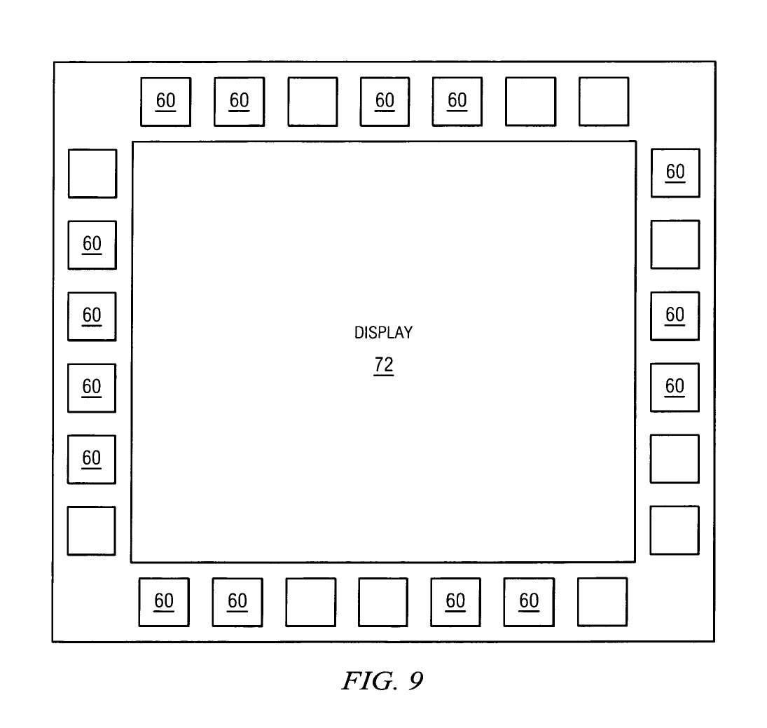

FIG. 4, which is the same as FIG. 3A of the above mentioned Meinel et al. application, shows a cross-section of an integrated circuit IR sensor chip 1 which includes silicon substrate 2 and cavity 4 therein, generally as shown in FIG. 2 except that chip 1 is inverted. Silicon substrate 2 includes a thin layer (not shown) of epitaxial silicon into which cavity 4 is etched, and also includes the silicon wafer substrate on which the original epitaxial silicon layer is grown. IR sensor chip 1 includes SiO₂ stack 3 formed on the upper surface of silicon substrate 2. SiO₂ stack 3 includes multiple oxide layers 3-1,2. . . 6 as required to facilitate fabrication within SiO₂ stack 3 of N-doped polysilicon layer 13, titanium nitride layer 15, tungsten contact layers 14-1, 14-2, 15-1, 15-2, and 17, first aluminum metalization layer M1, second aluminum metalization layer M2, third aluminum metalization layer M3, and various elements of CMOS circuitry in block 45. (More detail of an implementation of the CMOS circuitry in block 45 appears in FIGS. 8 and 9A in the above mentioned Meinel et al. application, Publication Number US 2010/0213373). Note however, that in some cases it may be economic and/or practical to provide only thermopile 7,8 on IR sensor chip 1 and provide all signal amplification, filtering, and/or digital or mixed signal processing on a separate chip or chips. The interface system receives the analog output signals generated by the infrared sensors, and the raw analog data is converted by an analog-to-digital converter into digital form which then is converted into digital vector data. The gesture recognition subsystem processes the vector data and converts it into information representative of the recognized gestures.

By way of definition, the term “gesture” as used herein is intended to encompass any hand movements utilized to communicate information to a computer or the like to enable it to interpret hand movements, perform writing operations, or perform drawing operations.

The various layers shown in dielectric stack 3, including polysilicon layer 13, titanium nitride layer 15, aluminum first metalization layer M1, aluminum second metalization layer M2, and aluminum third metalization layer M3 each are formed on a corresponding oxide sub-layer of dielectric stack 3. Thermopile 7,8 thus is formed within SiO₂ stack 3. Cavity 4 in silicon substrate 2 is located directly beneath thermopile junction 7, and therefore thermally insulates thermopile junction 7 from silicon substrate 2. However thermopile junction 8 is located directly adjacent to silicon substrate 2 and therefore is at essentially the same temperature as silicon substrate 2. A relatively long, narrow polysilicon trace 13 is disposed on a SiO₂ sub-layer 3-1 of dielectric stack 3 and extends between tungsten contact 14-2 (in thermopile junction 7) and tungsten contact 14-1 (in thermopile junction 8). Titanium nitride trace 15 extends between tungsten contact 15-1 (in thermopile junction 8) and tungsten contact 15-2 (in thermopile junction 7). Thus, polysilicon trace 13 and titanium nitride trace 15 both function as parts of thermopile 7,8. Thermopile 7,8 is referred to as a poly/titanium-nitride thermopile, since the Seebeck coefficients of the various aluminum traces cancel and the Seebeck coefficients of the various tungsten contacts 14-1, 14-2, 15-2, and 17 also cancel because the temperature difference across the various connections is essentially equal to zero.

The right end of polysilicon layer 13 is connected to the right end of titanium nitride trace 15 by means of tungsten contact 14-2, aluminum trace 16-3, and tungsten contact 15-2 so as to form “hot” thermopile junction 7. Similarly, the left end of polysilicon layer 13 is connected by tungsten contact 14-1 to aluminum trace 11 B and the left end of titanium nitride trace 15 is coupled by tungsten contact 15-1, aluminum trace 16-2, and tungsten contact 17 to aluminum trace 11A, so as to thereby form “cold” thermopile junction 8. The series-connected combination of the two thermopile junctions 7 and 8 forms thermopile 7,8.

Aluminum metalization interconnect layers M1, M2, and M3 are formed on the SiO₂ sub-layers 3-3, 3-4, and 3-5, respectively, of dielectric stack 3. A conventional silicon nitride passivation layer 12 is formed on another oxide sub-layer 3-6 of dielectric layer 3. A number of relatively small-diameter etchant holes 24 extend from the top of passivation layer 12 through dielectric stack 3 into cavity 4, between the various patterned metalization (M1, M2 and M3), titanium nitride, and polysilicon traces which form thermopile junctions 7 and 8.

Epoxy film 34 is provided on nitride passivation layer 12 to permanently seal the upper ends of etch openings 24 and to reinforce the “floating membrane” portion of dielectric layer 3. Although there may be some applications of the invention which do not require epoxy cover plate 34, the use of epoxy cover plate 34 is an important aspect of providing a reliable WCSP package configuration of the IR sensors of the present invention. In an embodiment of the invention under development, epoxy cover plate 34 is substantially thicker (roughly 16 microns) than the entire thickness (roughly 6 microns) of dielectric stack 3.

FIG. 5, which is the same as FIG. 5 of the above mentioned Meinel et al. pending application, shows a partial section view including an IR sensor device 27 that includes above described IR sensor chip 1 as part of a modified WCSP, wherein various solder bumps 28 are bonded to corresponding specialized solder bump bonding pads 28A or the like on IR sensor chip 1. The various solder bumps 28 are also bonded to corresponding traces 23A on a printed circuit board 23. Note that basic structure of the WCSP package in FIG. 5 may readily support a 2×2 IR sensor array on a single chip. Ordinarily, a solid upper surface (not shown) that is transparent to infrared radiation would be provided in order to protect the IR sensor chips (FIGS. 4 and 5) from being touched by a hand, finger, hand-held implement, or the like. The IR sensors may be 1.5 millimeters square or even smaller. The size of an entire array used in gesture recognition, on a large PC board or the like, could be, for example, one meter square, or the IR sensor array could be quite small, e.g., the size of a typical mouse pad, and could function as a virtual mouse.

The IR sensor devices 60-x,y shown in FIGS. 3-5 may be incorporated into various kinds of touch pad surfaces, computer mouse pad surfaces, touch screen surfaces, or the like of an input device for translating hand movement into hand movement vectors that are used to provide digital information to be input to a utilization device or system, for example as computer mouse replacements, as digital hand/finger movement sensing input devices for game controllers, and as digital hand/finger movement sensing input devices in a drawing tablet. The IR sensors may be located around the periphery of the screen, and may be operable to accurately detect hand movements “along” the surface of that screen. (By way of definition, the term “along”, as used to describe movement of a hand, finger, information-indicating element, or the like along the surface 55A of the array 55 of IR sensors, is intended to mean that the moving hand, finger, or information-indicating element touches or is near the surface 55A during the movement.)

Thus, an array of infrared sensors may be used to detect hand motion, and the translated vector of the motion of that hand (or the hand-held device such as a heated stylus) can be input into a display system that does not have touch-sensing capability, based on the temperature difference between the hand and the environment. The array of IR sensors can detect the spatial times at which an object such as a hand passes over the sensors and the direction of movement of the hand (or hand-held object or other object). The use of IR sensors means that no external light source or surface contact is needed. The array could be of any suitable dimensions and could be as small as a 2×1 array. And as previously mentioned, the IR sensor array surface may be planar, convex, or concave.

The use of long wavelength IR sensors means that no external lighting source is needed to generate the signal to the sensing array, and as previously mentioned, this may significantly simplify the required signal processing, compared to the signal processing required in the systems of Prior Art FIGS. 1 and 2.

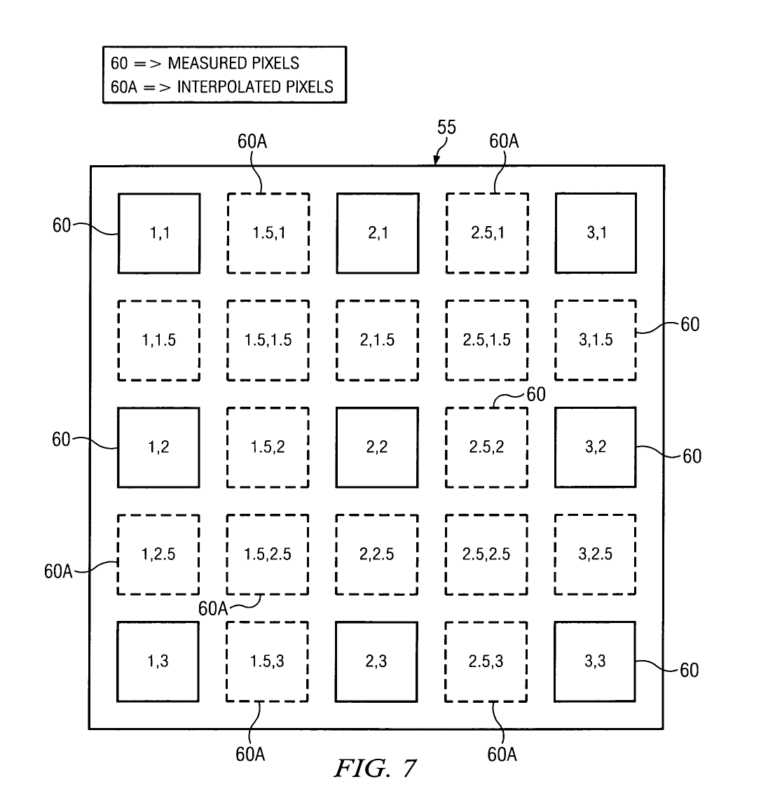

FIG. 6 shows a more detailed diagram of IR sensor array 55 of FIG. 3. For convenience, in this example a 3×3 implementation is shown including 9 IR sensors 60-1,1 through 60-3,3. Each IR sensor 60-x,y includes a structure generally as shown in previously described FIG. 4, wherein the CMOS circuitry 45 in each of the 9 IR sensors 60-x,y includes amplification and analog to digital conversion circuitry (as shown in FIG. 9A of the above mentioned Meinel et al. application) and also includes conventional I²C interface circuitry (not shown) which couples the digitized information to a conventional I²C bus 63. A microprocessor 64 or other suitable processing circuit also includes conventional I²C interface circuitry (not shown) and both controls the IR sensors 60-x,y and receives IR sensor output data from each IR sensor 60-x,y via an I²C bus or other suitable information bus. In FIG. 6, the I²C interface circuitry included in each of IR sensors 60-x,y and in processor 64 is connected to a two-wire I²C bus 63 (including a conventional serial clock SCLK conductor and a serial data bus SDA conductor) to which all of the IR sensors 60-x,y are connected. Processor 64 functions as the master in an I²C system and the IR sensors 60-x,y function as slaves. Note that processor 64 may be a microprocessor, a host processor, or a state machine. (By way of definition, the term “processor” as used herein is intended to encompass any suitable processing device, such as a microprocessor, host processor, and/or state machine. Also by way of definition, the term “bus” is used herein is intended to encompass either a digital bus or an analog bus, because in some cases it may be practical to utilize an analog bus to convey information from the IR sensors to a processing circuit.)

The processor determines the peak signal location and subtracts background levels for each time frame. It then tracks the locations of the peak signal in each time frame and, if desired, then calculates the appropriate hand/finger movement or gesture type. (For more information on conventional I²C systems, see “The I²C-Bus Specification, Version 2.1, January 2000”, which is incorporated herein by reference, and/or the article entitled “I²C” which is cited in and included with the Information Disclosure Statement submitted with this application, is also incorporated herein by reference, and is available at http://en.wikipedia.org/wiki/I%C2%B2C.)

It should be noted that each IR sensor in array 55 may be considered to⁻be a “pixel” of array 55, so the I²C interface circuitry in each IR sensor 60-x,y generates output data that is considered to be output data for a corresponding pixel. Microprocessor 64 scans all of the IR sensors 60-x,y essentially simultaneously in order to obtain all of the pixel data of IR sensor array 55 during one time frame.

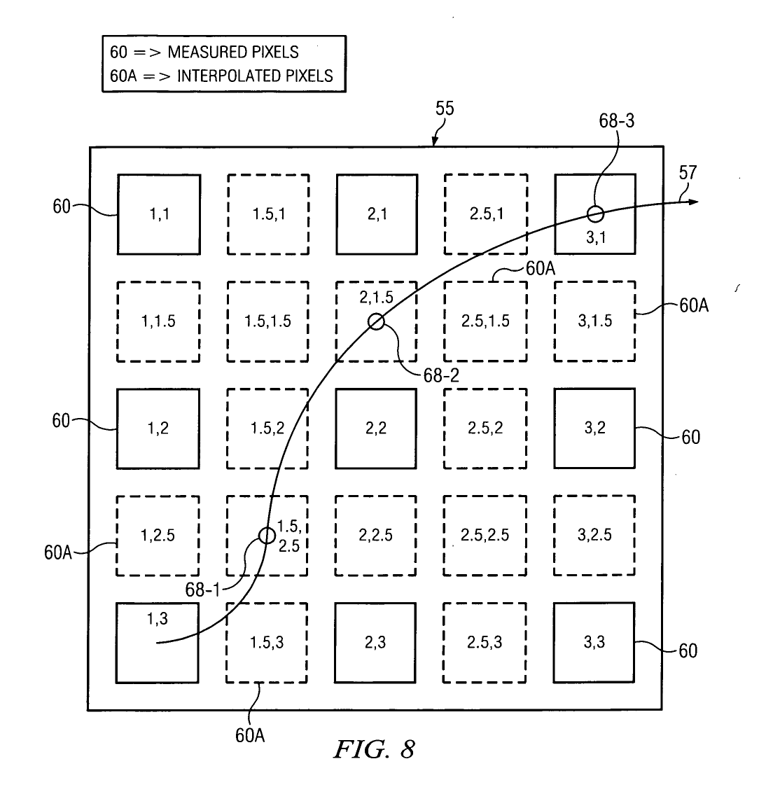

The space between the various pixels corresponding to the various IR sensors in 3×3 array 55 can be relatively large, as indicated in FIG. 7, in order to cover a large area and thereby reduce cost. In FIG. 7, there are no sensors actually located in the large dashed-line regions shown between the various pixels (i.e., between the various IR sensors 60-x,y) of array 55, but the square regions surrounded by dashed lines 60A may be considered to be “interpolated” pixels. As indicated within each of the dashed-line square regions 60A representing interpolated pixels, the column index “x” has the values 1, 1.5, 2, 2.5, and 3 corresponding to the five illustrated columns, respectively, and the row index “y” also has the values 1, 1.5, 2, 2.5, and 3 corresponding to the five illustrated rows, respectively. Values of pixel output signals associated with various interpolated pixels located among nearby IR sensors 60x,y may be readily computed using various conventional interpolation techniques, such as weighted averaging or cubic spline techniques, to determine the signal values associated with the various interpolated pixels. Using such interpolated pixel output signal values, in addition to the measured pixel output signal values generated by IR sensors 60-x,y wherein “x” can only have the values 1, 2, and 3 and “y” also can only have the values 1, 2, and 3, allows the resolution of IR sensor array 55 to be substantially increased.

FIG. 8 shows a computed vector 57 superimposed on the IR sensor array 55 of FIG. 7. Vector 57 is computed using the peak values produced by the various pixels in array 55 during each time frame in response to movement of a hand or the like along the surface of IR sensor array 55 (i.e., using the x, y coordinate values of the pixels which produce the peak values of all the thermoelectric output voltages Vout of the various IR sensors 60-x,y). With this information, vectors representing the hand motion may be produced using known techniques that may be similar to those indicated in Prior Art FIG. 2. That vector information may be input to gesture recognition modules that are similar to the one shown in Prior Art FIG. 1 or to other circuits or systems that are able to use such information. The example of FIG. 8 includes the peak pixel output signals caused by movement of a hand or the like across the surface of IR sensor array 55 over an interval of the three indicated time frames, during which the peak pixel output signal values are determined for the pixels in which circles 68-1, 68-2, and 68-3 are located. Vector 57 then is extrapolated by, in effect, drawing a smooth curve through those peak pixel value points. Vector 57 shows or tracks where the hand (or finger, stylus held by the fingers, or the like) was located at particular points in time. That is, output vector 57 represents locations, over time, of the peak values detected by IR sensing array 55. The peak value at each time frame thus is an amplified and in some cases interpolated thermoelectric voltage based on data from all of the IR sensors of the array. However, more than one peak may be determined so that multiple hand movements and/or gestures may be interpreted simultaneously.

FIG. 9 shows a display screen 72, which could be an ordinary LCD screen, surrounded by a suitable number of IR sensors 60. The temperature difference between a hand, finger, or the like moving over or along the surface of display 72 and the thermopiles in the various IR sensors 60 is detected by all of IR sensors 60, with varying degrees of sensitivity dependent on the distance of the hand or finger from each sensor. During each time frame, digital representations of the temperature differences all are output by all of IR sensors 60 onto the common I²C bus 63 (see FIG. 6) by the I²C interface circuitry associated with each IR sensor 60 during each time frame. This information is read by microprocessor 64 and is processed by a suitable recognition program executed by microprocessor 64 (or by a more powerful host processor coupled to microprocessor 64) to determine the value of a vector that represents the position of the hand, finger, or the like at each time frame and also represents the direction of movement of the hand, finger, or the like.

The diagrams of FIGS. 6 through 9 show that the described embodiments of the invention are parts of complex systems which interpret hand movement or movement of other elements to provide digital input information to such systems.

Although the above described embodiments of the invention refer to interpreting, translating, or tracking movement of a human hand, finger, or the like into useful digital information, the moving element being interpreted, transmitted, or tracked could be any element having a temperature difference relative to the thermopiles of the IR sensors. For example, the moving element may be a heated stylus held by the hand, or it may be anything having a temperature different than the background ambient temperature.

As a practical matter, the described technique using the assignee's disclosed infrared detectors (FIGS. 4 and 5) under development may be mainly a two-dimensional technique or a technique wherein the hand or element being tracked moves near or slides along the surface 55A in which the IR sensors are embedded. However, IR sensor output signals generally are a distinct function of distance along a z-axis, even though this aspect of the IR sensors has not yet been accurately characterized. Therefore, it is entirely possible that three-dimensional tracking of movement of a hand or other moving element may be advantageously accomplished by the described hand tracking systems including IR sensors.

Advantages of the described embodiments of the invention include higher system operating speed, lower cost, and greater ease of use than the prior art systems for detecting and quantifying hand movement or the like to provide corresponding digital input information to a utilization system or device. One important advantage of using IR sensors for tracking of movement of a hand, finger, or other element is that the IR sensors are insensitive to ambient lighting conditions. Another advantage of the IR sensors is that they do not have to be densely located in the screen or sensor surface. One likely application of the described embodiments is to replace a computer mouse, perhaps with a larger area of surface 55A than the surface on which a typical mouse is typically used.

While the invention has been described with reference to several particular embodiments thereof, those skilled in the art will be able to make various modifications to the described embodiments of the invention without departing from its true spirit and scope. It is intended that all elements or steps which are insubstantially different from those recited in the claims but perform substantially the same functions, respectively, in substantially the same way to achieve the same result as what is claimed are within the scope of the invention.

What is claimed is:

1. A system for generating tracking coordinate information in response to movement of an information-indicating element, comprising:
(a) an array of IR (infrared) sensors disposed along a surface of the array;
(b) each IR sensor including
first and second thermopile junctions connected in series to form a thermopile within a dielectric stack of a radiation sensor chip, the first thermopile junction being more thermally insulated from a substrate of the radiation sensor chip than the second thermopile junction, a sensor output signal between the first and second thermopile junctions being coupled to a bus; and
(c) a processing device coupled to the bus for receiving information representing temperature differences between the first and second thermopile junctions of the various IR sensors, respectively, caused by the presence of the information-indicating element, the processing device operating on the information representing the temperature differences to produce the tracking coordinate information as the information-indicating element moves along the surface.

2. The system of claim 1 wherein the surface lies along surfaces of the substrates of the radiation sensor chips.

3. The system of claim 1 wherein each first thermopile junction is insulated from the substrate by means of a corresponding cavity between the substrate and the dielectric stack.

4. The system of claim 1 wherein a plurality of bonding pads coupled to the thermopile are disposed on the radiation sensor chip, and a plurality of bump conductors are attached to the bonding pads, respectively, for physically and electrically coupling the radiation sensor chip to conductors on a circuit board.

5. The system of claim 1 wherein the dielectric stack is a CMOS semiconductor process dielectric stack including a plurality of SiO₂ sublayers and various polysilicon traces, titanium nitride traces, tungsten contacts, and aluminum metalization traces between the various sublayers patterned to provide the first and second thermopile junctions connected in series to form the thermopile, and wherein each IR sensor includes CMOS circuitry coupled between first and second terminals of the thermopile to receive and operate on a thermoelectric voltage generated by the thermopile in response to infrared (IR) radiation received by the radiation sensor chip, the CMOS circuitry also being coupled to the bonding pads.

6. The system of claim 5 wherein the CMOS circuitry converts the thermoelectric voltage to digital information in an PC format and sends the digital information to the processing device via the bus.

7. The system of claim 5 wherein the processing device operates on the digital information to generate a sequence of vectors that indicate locations and directions of the information-indicating element as it moves along the surface.

8. The system of claim 7 wherein the information-indicating element includes at least part of a human hand, and the processing device operates on the vectors to interpret gestures represented by the movement of the hand along the surface.

9. The system of claim 1 wherein the IR sensors are represented by measured pixels which are spaced apart along the surface.

10. The system of claim 1 wherein the IR sensors are disposed along a periphery of a display to produce temperature differences between the first and second thermopile junctions of the various IR sensors caused by the presence of the information-indicating element as it moves along the surface of the display.

11. The system of claim 1 wherein the IR sensors are represented by measured pixels which are spaced apart along the surface, and wherein the processing device interpolates values of various interpolated pixels located between various measured pixels.

12. The system of claim 1 wherein the substrate is composed of silicon to pass infrared radiation to the thermopile and block visible radiation, and further including a passivation layer disposed on the dielectric stack, a plurality of generally circular etchant openings located between the various traces and extending through the passivation layer and the dielectric layer to the cavity for introducing silicon etchant to produce the cavity by etching the silicon substrate.

13. The system of claim 1 wherein the processing device includes a microprocessor.

14. The system of claim 1 wherein the radiation sensor chip is part of a WCSP (wafer chip scale package).

15. A method for generating tracking coordinate information in response to movement of an information-indicating element, the method comprising:
(a) providing an array of IR (infrared) sensors disposed along a surface of the array, each IR sensor including first and second thermopile junctions connected in series to form a thermopile within a dielectric stack of a radiation sensor chip, the first thermopile junction being more thermally insulated from a substrate of the radiation sensor chip than the second thermopile junction, a sensor output signal between the first and second thermopile junctions being coupled to a bus;
(b) coupling a processing device to the bus;
(c) operating the processing device to receive information representing temperature differences between the first and second thermopile junctions of the various IR sensors, respectively, caused by the presence of the information-indicating element; and
(d) causing the processing device to operate on the information representing the temperature differences to produce the tracking coordinate information as the information-indicating element moves along the surface.

16. The method of claim 15 wherein the substrate is composed of silicon to pass infrared radiation to the thermopile and block visible radiation, and wherein step (a) includes providing the surface along surfaces of the substrates of the IR sensors and providing a cavity between the substrate and the first thermopile junction to thermally insulate the first thermopile junction from the substrate.

17. The method of claim 15 wherein step (a) includes providing the radiation sensor chip as part of a WCSP (wafer chip scale package).

18. The method of claim 15 wherein the bus is an I²C bus, and wherein step (a) includes providing I²C interface circuitry coupled between the I²C bus and first and second terminals of the thermopile.

19. The method of claim 18 wherein step (a) includes providing CMOS circuitry which includes the I²C interface circuitry in each IR sensor coupled between the first and second terminals of the thermopile to receive and operate on a thermoelectric voltage generated by the thermopile in response to infrared (IR) radiation received by the radiation sensor chip.

20. A system for generating tracking coordinate information in response to movement of an information-indicating element, comprising:
(a) an array of IR (infrared) sensors disposed along a surface of the array, each IR sensor including first and second thermopile junctions connected in series to form a thermopile within a dielectric stack of a radiation sensor chip, the first thermopile junction being more thermally insulated from a substrate of the radiation sensor chip than the second thermopile junction, a sensor output signal between the first and second thermopile junctions being coupled to a bus; and
(b) processing means coupled to the bus for operating on information representing temperature differences between the first and second thermopile junctions of the various IR sensors, respectively, caused by the presence of the information-indicating element to produce the tracking coordinate information as the information-indicating element moves along the surface.
